(19) United States
(12) Patent Application Publication
(10) Pub. No.: US 2026/0129206 A1
(43) Pub. Date: May 7, 2026

(54) SIGNALING DUAL DEGREE INFORMATION FOR POLYGON MESH COMPRESSION

(71) Applicant: TENCENT AMERICA LLC, Palo Alto, CA (US)

(72) Inventors: Chao HUANG, Palo Alto, CA (US); Shan LIU, San Jose, CA (US)

(73) Assignee: TENCENT AMERICA LLC, Palo Alto, CA (US)

(21) Appl. No.: 19/302,276

(22) Filed: Aug. 18, 2025

Related U.S. Application Data
(60) Provisional application No. 63/715,482, filed on Nov. 1, 2024.
(60) Provisional application No. 63/720,131, filed on Nov. 13, 2024.

(51) Int. Cl. H04N 19/136; G06T 9/00; H04N 19/70

(52) U.S. Cl. CPC H04N 19/136; G06T 9/001; H04N 19/70

(57) ABSTRACT

A method of encoding includes receiving a polygon mesh comprising a plurality of vertices defining a plurality of faces; determining, for at least a portion of the polygon mesh, a mesh face type; determining, using the mesh face type, a first parameter corresponding to a face degree mode; encoding, using the mesh face type, the first parameter corresponding to the face degree mode; and generating a bitstream comprising the polygon mesh encoded in accordance with a dual degree process, the mesh face type, and the first parameter.

### CROSS-REFERENCE TO RELATED APPLICATION

This application claims priority from U.S. Provisional Application No. 63/715,482 filed on Nov. 1, 2024, and U.S. Provisional Application No. 63/720,131 filed on Nov. 13, 2024, the disclosure of each of which are incorporated herein by reference in their entirety.

### FIELD

This disclosure is directed to a set of advanced video coding technologies. More specifically, the present disclosure is directed to signaling dual degree information for polygon mesh compression.

### BACKGROUND

The connectivity of a polygon mesh can be coded with either the polygon-fan method or the dual-degree method, both of which require the face and vertex information of the mesh, such as the mesh face type, vertex degree mode, face degree mode. The vertex degree of a vertex is the number of incident faces, and the face degree of a face is the number of incident vertices. The vertex degree mode and face degree mode of a mesh are the most frequent vertex degree, the most frequent face degree in the mesh, respectively.

To code the connectivity of a polygon mesh, we can employ the dual-degree method, which uses the certain geometry information of the mesh, such as the vertex degree mode, face degree mode, dummy face degree mode, maximum face degree, minimum face degree, etc. The vertex degree of a vertex is the number of incident faces, and the face degree of a face is the number of incident vertices. The vertex degree mode, face degree mode and dummy face degree mode of a mesh are the most frequent vertex degree, the most frequent face degree and the most frequent dummy face degree in the mesh, respectively.

### SUMMARY

According to embodiments of the present disclosure, a method of encoding performed by at least one processor includes receiving a polygon mesh comprising a plurality of vertices defining a plurality of faces; determining, for at least a portion of the polygon mesh, a mesh face type; determining, using the mesh face type, a first parameter corresponding to a face degree mode; encoding, using the mesh face type, the first parameter corresponding to the face degree mode; and generating a bitstream comprising the polygon mesh encoded in accordance with a dual degree process, the mesh face type, and the first parameter.

According to embodiments of the present disclosure, a method of decoding includes receiving a bitstream comprising a polygon mesh, in accordance with a dual degree process, a mesh face type for at least a portion of the polygon mesh, and a first parameter corresponding to the face degree mode for at least a portion of the mesh; and decoding, using the mesh face type, the face degree mode; decoding the portion of the polygon mesh using the mesh face type and the face degree mode.

According to embodiments of the present disclosure, a method of encoding a polygon mesh includes: generating a bitstream comprising the polygon mesh that comprises a plurality of vertices defining a plurality of faces, in which for at least a portion of the polygon mesh, a mesh face type is determined, in which using the mesh face type, a first parameter corresponding to a face degree mode is determined; in which using the mesh face type, the first parameter corresponding to the face degree mode is encoded, and in which the bitstream comprises the polygon mesh encoded in accordance with a dual degree process, the mesh face type, and the face degree mode is generated; and transmitting the generated bitstream.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of a block diagram of a communication system, in accordance with embodiments of the present disclosure.

FIG. 2 is a schematic illustration of a block diagram of a streaming system, in accordance with embodiments of the present disclosure.

FIG. 3 is a schematic illustration of an example mesh encoder, in accordance with embodiments of the present disclosure.

FIG. 4 is a flowchart of an example process for encoding a mesh, in accordance with embodiments of the present disclosure.

FIG. 5 illustrates and example process for geometry encoding, in accordance with embodiments of the present disclosure.

FIG. 6 illustrates an example process for how each slice is encoded, in accordance with embodiments of the present disclosure.

FIGS. 7-9 illustrate lossless results of adding a geometry slice layer (no adaptive coding mode) vs. TM 5.0a with default cfgs, in accordance with embodiments of the present disclosure.

FIGS. 10-12 illustrate lossless results of adding the geometry slice layer plus adaptive coding mode vs. TM 5.0 per-mesh cfgs, in accordance with embodiments of the present disclosure.

FIGS. 13-15 illustrate additional lossless results of adding a geometry slice layer (no adaptive coding mode) vs. TM 5.0a with default cfgs, in accordance with embodiments of the present disclosure.

FIGS. 16-18 illustrate additional lossless results of adding the geometry slice layer plus adaptive coding mode vs. TM 5.0 per-mesh cfgs, in accordance with embodiments of the present disclosure.

FIGS. 19 and 20 illustrate results of Dual-degree-26c6346a vs. P01T0, in accordance with embodiments of the present disclosure.

FIGS. 21 and 22 illustrate results of Parallelogram-prediction-a8fc726b vs. Dual-degree-26c6346a, in accordance with embodiments of the present disclosure.

FIGS. 23 and 24 illustrate results of reflection-prediction-6f012e07 v. parallelogram-prediciton-a8fc726b, in accordance with embodiments of the present disclosure.

FIG. 25 illustrates results specialUV-handing-9a10dee4 vs. reflection-prediction-6f012e07, in accordance with embodiments of the present disclosure.

FIGS. 26-28 illustrate results of test model v1.0 vs. P01 (lossless), in accordance with embodiments of the present disclosure.

FIG. 29 illustrates an example performance of an integrated symmetric coding tool, in accordance with embodiments of the present disclosure.

FIG. 30 illustrates an example lossy coding performance of test model 1.0 with the integrated symmetric coding tool, in accordance with embodiments of the present disclosure.

FIG. 31 illustrates an example computer system, in accordance with embodiments of the present disclosure.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

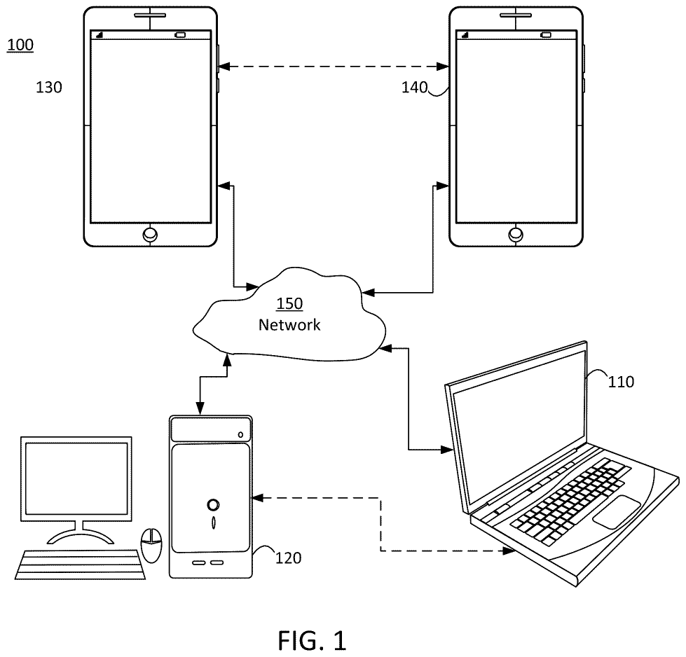

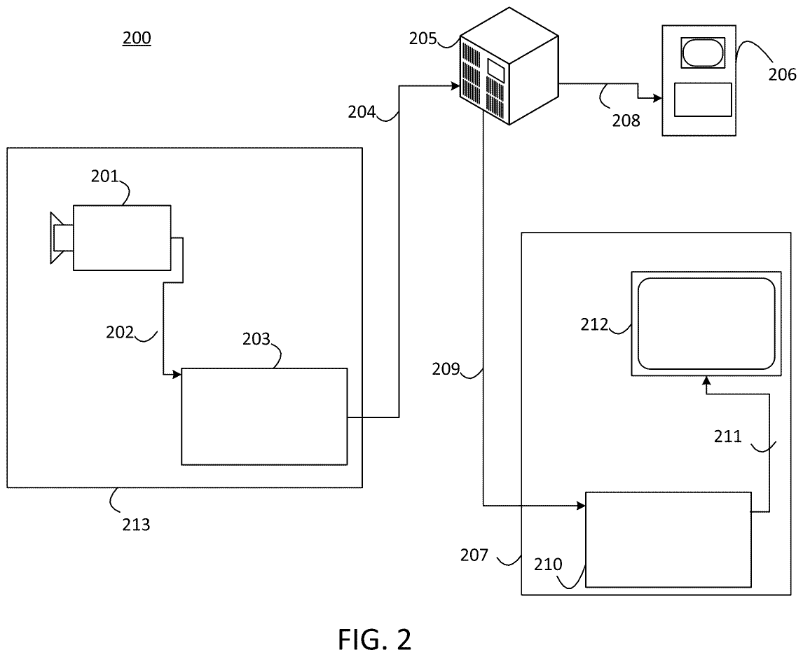

With reference to FIGS. 1-2, one or more embodiments of the present disclosure for implementing encoding and decoding structures of the present disclosure are described.

FIG. 1 illustrates a simplified block diagram of a communication system 100 according to an embodiment of the present disclosure. The system 100 may include at least two terminals 110, 120 interconnected via a network 150. For unidirectional transmission of data, a first terminal 110 may code video data, which may include mesh data, at a local location for transmission to the other terminal 120 via the network 150. The second terminal 120 may receive the coded video data of the other terminal from the network 150, decode the coded data and display the recovered video data. Unidirectional data transmission may be common in media serving applications and the like.

FIG. 1 illustrates a second pair of terminals 130, 140 provided to support bidirectional transmission of coded video that may occur, for example, during videoconferencing. For bidirectional transmission of data, each terminal 130, 140 may code video data captured at a local location for transmission to the other terminal via the network 150. Each terminal 130, 140 also may receive the coded video data transmitted by the other terminal, may decode the coded data and may display the recovered video data at a local display device.

In FIG. 1, the terminals 110-140 may be, for example, servers, personal computers, and smart phones, and/or any other type of terminals. For example, the terminals (110-140) may be laptop computers, tablet computers, media players and/or dedicated video conferencing equipment. The network 150 represents any number of networks that convey coded video data among the terminals 110-140 including, for example, wireline and/or wireless communication networks. The communication network 150 may exchange data in circuit-switched and/or packet-switched channels. Representative networks include telecommunications networks, local area networks, wide area networks, and/or the Internet. For the purposes of the present discussion, the architecture and topology of the network 150 may be immaterial to the operation of the present disclosure unless explained herein below.

FIG. 2 illustrates, as an example of an application for the disclosed subject matter, a placement of a video encoder and decoder in a streaming environment. The disclosed subject matter may be used with other video enabled applications, including, for example, video conferencing, digital TV, storing of compressed video on digital media including CD, DVD, memory stick and the like, and so on.

As illustrated in FIG. 2, a streaming system 200 may include a capture subsystem 213 that includes a video source 201 and an encoder 203. The streaming system 200 may further include at least one streaming server 205 and/or at least one streaming client 206.

The video source 201 may create, for example, a stream 202 that includes a 3D mesh and metadata associated with the 3D mesh. The video source 201 may include, for example, 3D sensors (e.g. depth sensors) or 3D imaging technology (e.g. digital camera(s)), and a computing device that is configured to generate the 3D mesh using the data received from the 3D sensors or the 3D imaging technology. The sample stream 202, which may have a high data volume when compared to encoded video bitstreams, may be processed by the encoder 203 coupled to the video source 201. The encoder 203 may include hardware, software, or a combination thereof to enable or implement aspects of the disclosed subject matter as described in more detail below. The encoder 203 may also generate an encoded video bitstream 204. The encoded video bitstream 204, which may have a lower data volume when compared to the uncompressed stream 202, may be stored on a streaming server 205 for future use. One or more streaming clients 206 and 207 may access the streaming server 205 to retrieve video bit streams 208 and 209, respectively that may be copies of the encoded video bitstream 204.

The streaming clients 207 may include a video decoder 210 and a display 212. The video decoder 210 may, for example, decode video bitstream 209, which is an incoming copy of the encoded video bitstream 204, and create an outgoing video sample stream 211 that may be rendered on the display 212 or another rendering device (not depicted). In some streaming systems, the video bitstreams 204, 208, and 209 may be encoded according to certain video coding/compression standards.

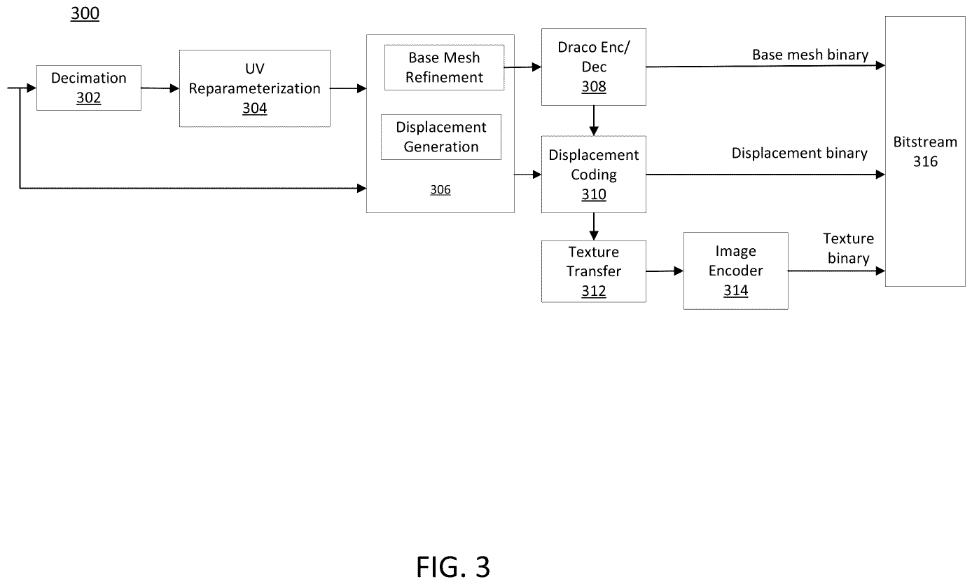

FIG. 3 illustrates an example mesh encoder 300. The encoder 300 may perform the V-DMC process for performing decimation and reparameterization before encoding a bitstream. As illustrated in FIG. 3, an input mesh may be subject to decimation 302 and UV reparameterization 304. Subsequently geometry reparameterization 306 is performed that includes base mesh refinement and displacement generation. The output of the base mesh refinement is provided to a Draco encoder 308 to generate a base mesh binary. The output of the displacement generation is provided to displacement coding 310 to generate displacement binary. The output of displacement coding 310 is provided to texture transfer 312 and image encoder 314 to generate texture binary. The base mesh binary, texture binary, and displacement binary may be included in bitstream 316. In one or more examples, texture coordinates or UV coordinates (often shortened to UVs) map the vertices to locations on the textures through a process called “UV Mapping”. The UVs define a 2D position in texture space for each vertex in the mesh.

The face and vertex information of the mesh needs to be signaled to decode the bitstream produced by the polygon-fan method or the dual-degree method.

The embodiments are directed to signaling of face and vertex information for polygon mesh compression.

The embodiments of the present disclosure may be applied to the polygon mesh header and/or the header of a group of connected components (GOCC) in a mesh. According to one or more embodiments, a polygon mesh header is used, which can be readily translated to the header of a GOCC.

In one or more examples, the mesh face type can be coded using 2 bits and the correspondence between the codewords and the face types are given in Table 1:

TABLE 1

| u(2) codeword | face type |
|---|---|
| 00 | 0 (triangle) |
| 01 | 1 (quad) |
| 10 | 2 (tri-quad) |
| 11 | 3 (polygon) |

In one or more examples, the binary 0/1 in above codewords can be flipped. In one or more examples, a “tri-quad” face type means the faces of the mesh consists of triangles and quads, and a “polygon” face type means the mesh contain polygon faces other than triangles and quads.

In one or more examples, the mesh face type may be signaled as illustrated in Table 2.

TABLE 2

| | Descriptor |
|---|---|
| mesh_face_type( ) { | |
| single_face_type | u(1) |
| if (single_face_type == 1) { | |
| face_degree_minus3 | ue(v) |
| } else { | |
| two_face_type | u(1) |
| if (two_face_type == 1) { | |
| face_degree1_minus3 | ue(v) |
| face_degree2_minus3 | ue(v) |
| } | |
| } | |
| } | |

In one or more examples, “single_face_type” and “two_face_type” may mean that the mesh has one and two face types, respectively. In one or more examples, “face_degree1_minus3” and “face_degree2_minus3” mean the face degrees of the two face types.

In one or more examples, the face degree mode may be signaled as illustrated in Table 3.

TABLE 3

| | Descriptor |
|---|---|
| face_degree_mode( ) { | |
| if (mesh_face_type == tri-quad) { | |
| face_degree_mode_minus3 | u(1) |
| } (mesh_face_type == polygon) { | |
| face_degree_mode_minus3 | ue(v) |
| } | |

In one or more examples, the vertex degree mode can be signaled as illustrated in Table 4.

TABLE 4

| | Descriptor |
|---|---|
| vertex_degree_mode( ) { | |
| vertex_degree_mode | ue(v) |
| } | |

In one or more examples, the vertex degree mode may be signaled as illustrated in Table 5.

TABLE 5

| | Descriptor |
|---|---|
| vertex_degree_mode( ) { | |
| if (face_degree_mode == 3) { | |
| vertex_degree_mode_pred = 6 | |
| } else if (face_degree_mode == 4) { | |
| vertex_degree_mode_pred = 4 | |
| } else if (face_degree_mode == 0) { | |
| vertex_degree_mode_pred = 0 | |
| } else { | |
| vertex_degree_mode_pred = 3 | |
| } | |
| vertex_degree_mode_residual = | se(v) |
| true_vertex_degree_mode − | |
| vertex_degree_mode_pred | |
| } | |

In one or more examples, the vertex degree mode may be coded using 2 bits and the correspondence between the codewords and the face types are given in Table 6.

TABLE 6

| vertex degree mode codeword | vertex degree mode |
|---|---|
| 00 | 6 |
| 01 | 4 |
| 10 | 1 |
| 11 | subsequentially decoded |

TABLE 7

| | Descriptor |
|---|---|
| vertex_degree_mode( ) { | |
| vertex_degree_mode_codeword | u(2) |
| if (vertex_degree_mode_codeword == 11) | |
| vertex_degree_mode_pred = 3 | |
| vertex_degree_mode_residual = | se(v) |
| true_vertex_degree_mode − | |
| vertex_degree_mode_pred | |
| } | |
| } | |

In one or more examples, “vertex_degree_mode_pred” may be any integer.

The embodiments are directed to signaling of dual-degree information for polygon mesh compression.

To decode the bitstream produced the dual-degree method, certain information used by the dual-degree method needs to be signaled.

The embodiments of the present disclosure may be applied to polygon meshes and/or connected components in a mesh as long as they are coded by the dual-degree method. In one or more examples, a polygon mesh that is coded by the dual-degree method may be used as an example, which can be readily translated to the cases where connected components are coded by the dual-degree method.

TABLE 8

| | Descriptor |
|---|---|
| signal_dual_degree_info( ) { | |
| signal_vertex_degree_mode( ) | see below |
| dummy_face_degree_mode_minus3 | ue(v) |
| if (mesh_face_type == tri-quad) | |
| face_degree_mode_minus3 | u(1) |
| face_degree_mode_minus_min_face_degree | u(1) |
| max_face_degree_minus_face_degree_mode | u(1) |
| } else if (mesh_face_type == polygon) { | |
| face_degree_mode_minus3 | ue(v) |
| face_degree_mode_minus_min_face_degree | ue(v) |
| max_face_degree_minus_face_degree_mode | ue(v) |
| } | |

In one or more examples, “mesh_face_type==tri-quad” may mean the faces of the mesh consists of triangles and quads, and “mesh_face_type==polygon” may mean the faces of the mesh contain polygons other than triangles and quads.

TABLE 9

| | Descriptor |
|---|---|
| signal_vertex_degree_mode( ) { | |
| if (face_degree_mode == 3) { | |
| vertex_degree_mode_pred = 6 | |
| } else if (face_degree_mode == 4) { | |
| vertex_degree_mode_pred = 4 | |
| } else if (face_degree_mode == 0) { | |
| vertex_degree_mode_pred = 0 | |
| } else { | |
| vertex_degree_mode_pred = 3 | |
| } | |
| vertex_degree_mode_residual = | se(v) |
| vertex_degree_mode − vertex_degree_mode_pred | |
| } | |

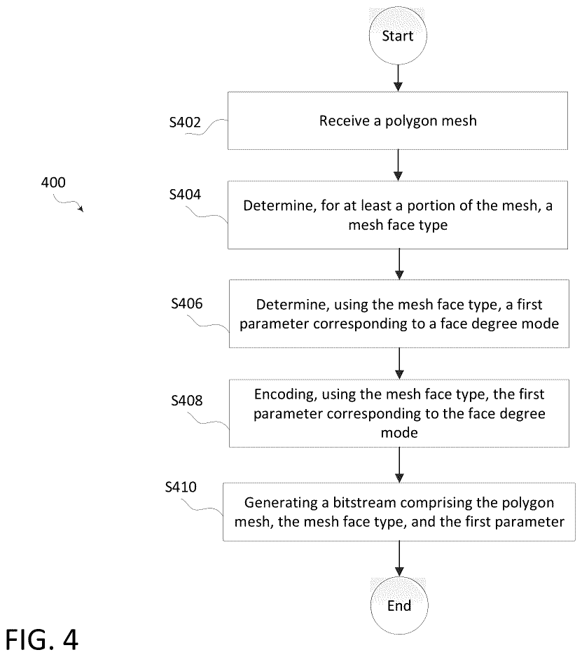

FIG. 4 is a flowchart of an example process 400 for encoding a mesh. 2e process may start at operation S402 where a polygon mesh is received. The process proceeds to operation S404 where a mesh face type is determined for a mesh. Operation S404 may be performed on a sub-mesh (e.g., portion of a mesh). The process proceeds to operation S406 where a first parameter corresponding to a face degree mode is determined using a mesh face type. The process proceeds to operation S408 where the first parameter is encoded using the mesh face type. Operations S404-S408 may be performed for each sub-mesh of the received polygon mesh. The process proceeds to operation S410 where a bitstream comprising the polygon mesh, the mesh face type, and the first parameter is generated.

A decoding process may be performed on the bitstream generated in process 400. The bitstream may be received by a decoder where the first parameter and mesh face type are decoded from the bitstream. Subsequently, the polygon mesh, or a sub-mesh of the polygon mesh may be decoded using the first parameter and mesh face type.

Embodiments are directed to high-level syntaxes of geometry mesh-parts and geometry slices with geometry slice encoders and decoders. The geometry mesh-part encoder and decoder are also updated.

Embodiments include a method to adaptively determine the geometry indices coding method for each connected component (CC) in the input mesh based on the topological characteristics of each CC. However, alternatingly running different code paths may affect the coding performance, therefore it is desired to partition CCs into different groups according to their code modes. In one or more examples, a group of CCs in the position attribute is named geometry slice and the original geometry slice is renamed to geometry mesh-part.

The current codes have been refactored by replacing *Slice* with *MeshPart* for all attributes. For example, “encodeSlice” is renamed to “encodeMeshPart”. A new struct “GeometryIntraSliceHeader” is created for signaling information of geometry slices according to the discussion in WDFG. Encoders and decoders of geometry slices are also created. First, classes named “GeometrySliceBaseEncoder” and “GeometrySliceBaseDecoder” are created as the base classes for geometry slice encoders and decoders, respectively. Then two derived classes “GeometrySlicePolygonFanEncoder” and “GeometrySliceDualDegreeEncoder” are created for the polygon-fan encoding mode and the dual-degree encoding mode, respectively. The corresponding derived classes “GeometrySlicePolygonFanDecoder” and “GeometrySliceDualDegreeDecoder” are also created. The base classes implement the common functions used by the derived classes, such as “encodeSliceHeader( )” and “decodeSliceHeader( )” etc. The derived classes implement their own functions used by the corresponding coding modes.

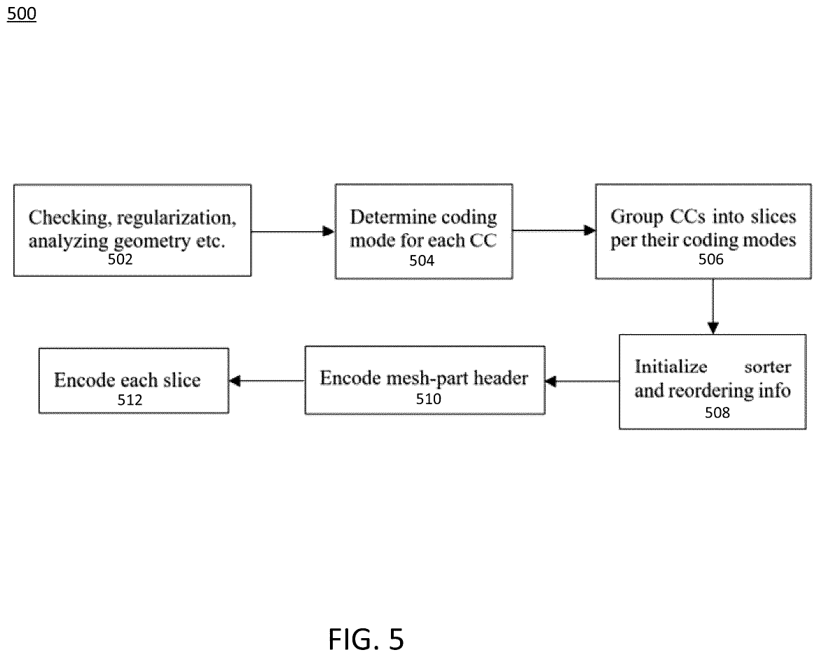

FIG. 5 illustrates an example flowchart of a process 500 for geometry encoding. The process may start at operation 502 for checking, regularization, analyzing of geometry etc. The process proceeds to operation 504 to determine a coding mode for each CC. The process proceeds to operation 506 to group CCs into slices per their coding modes. The process proceeds to operation 508 to initialize sorter and reordering info. The process proceeds to operation 501 to encode a mesh-part header. The process proceeds to operation 512 to encode each slice.

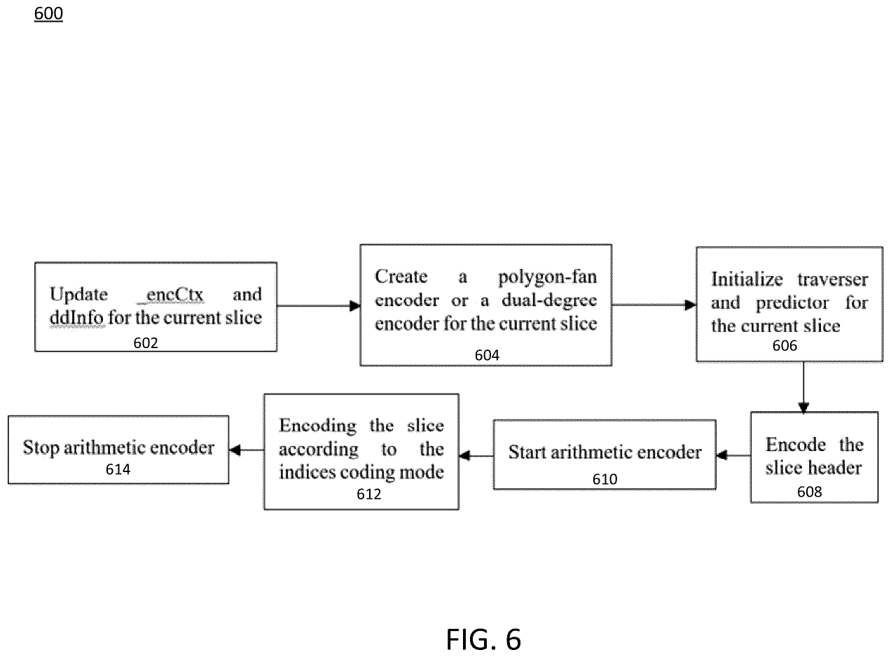

FIG. 6 illustrates an example flowchart of a process 600 for how each slice is encoded. The process may start at operation 602 to update the parameter_encCtx and ddInfo for a current slice. The process proceeds to operation 604 to create a polygon-fan encoder or a dual-degree encoder for the current slice. The process proceeds to operation initialize traverser and predictor for the current slice 606. The process proceeds to encode a slide header 608. The process proceeds to operation 610 to start an arithmetic encoder. The process proceeds to operation 612 to encode a slice according to the indices coding mode. The process proceeds to operation 614 to stop the arithmetic encoder.

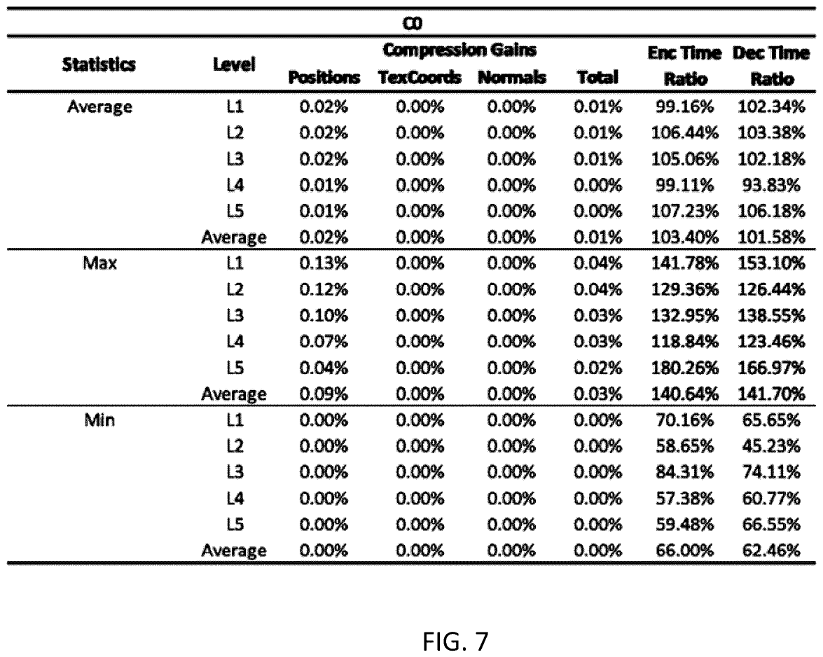

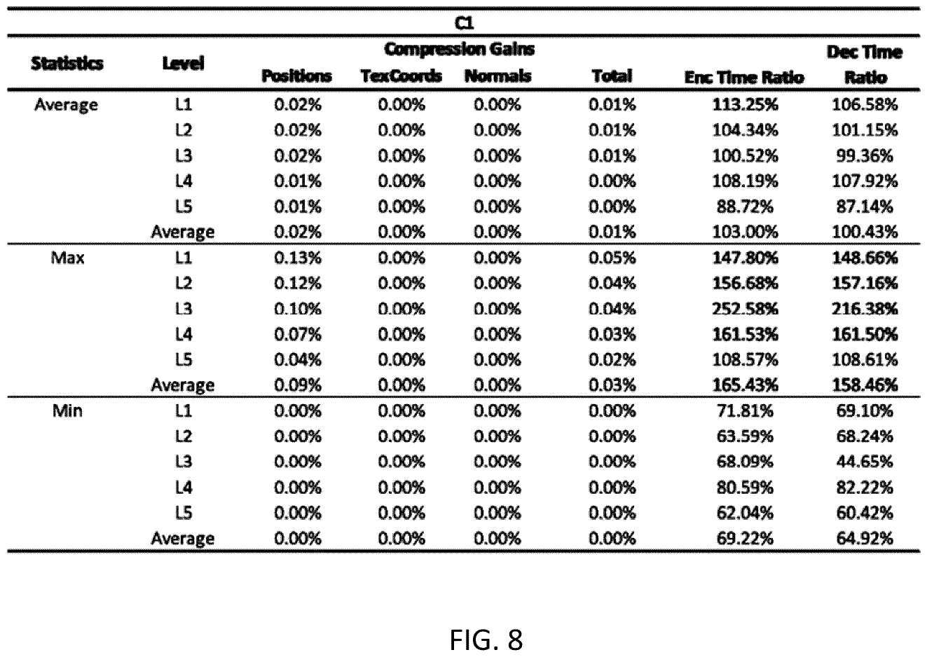

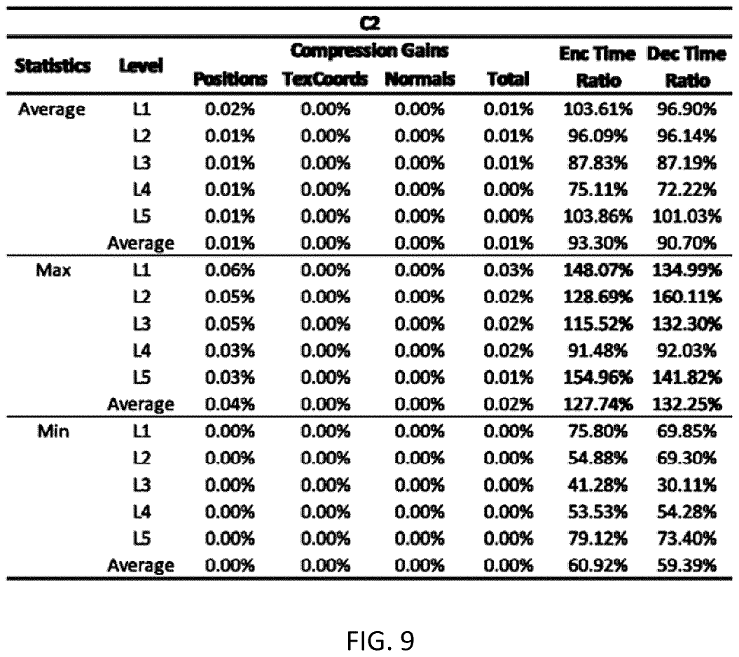

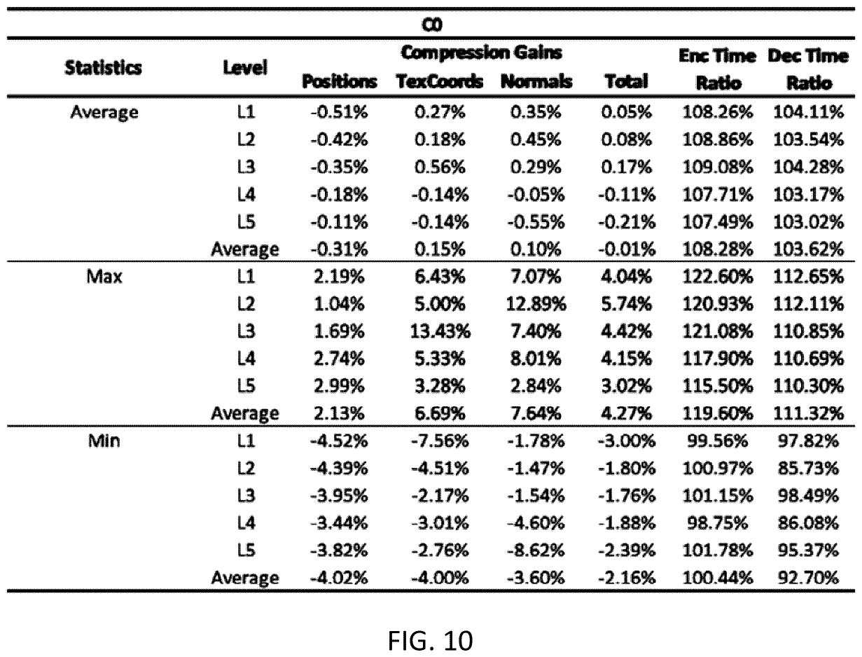

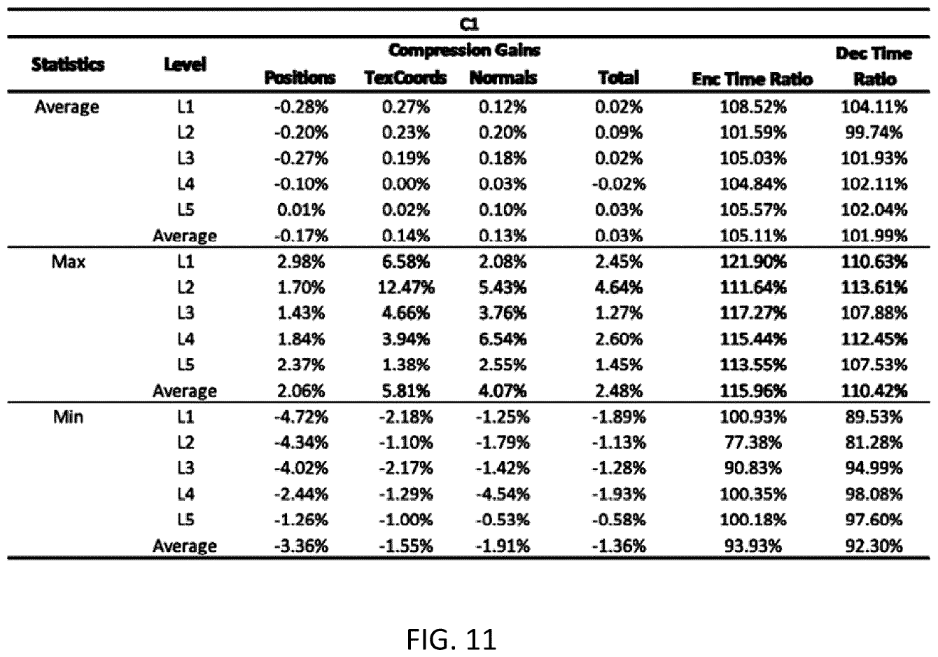

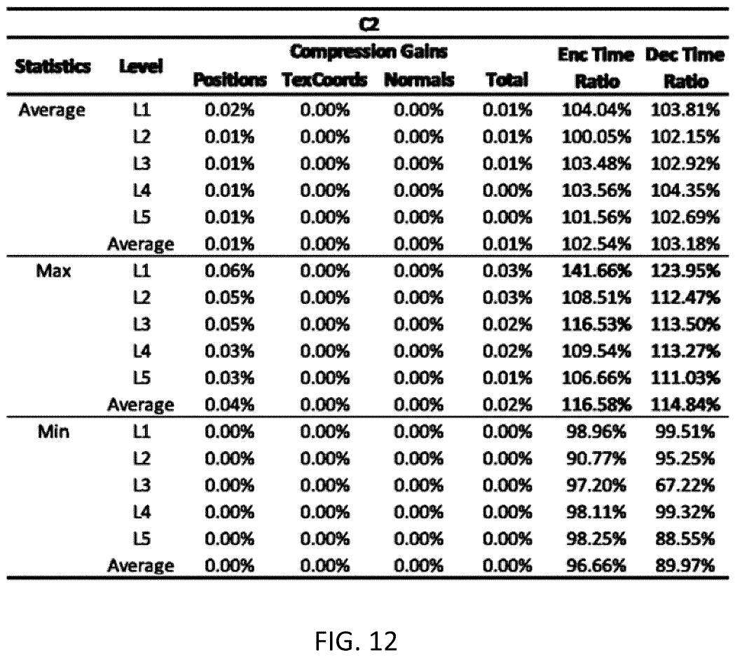

FIGS. 7-9 illustrate lossless results of adding a geometry slice layer (no adaptive coding mode) vs. TM 5.0a with default cfgs. FIGS. 10-12 illustrate lossless results of adding the geometry slice layer plus adaptive coding mode vs. TM 5.0 per-mesh cfgs.

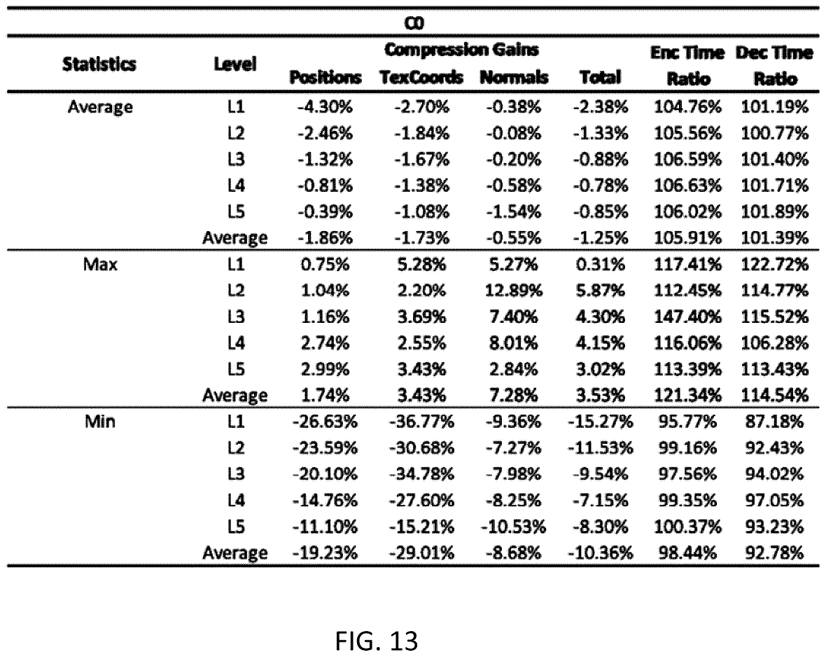

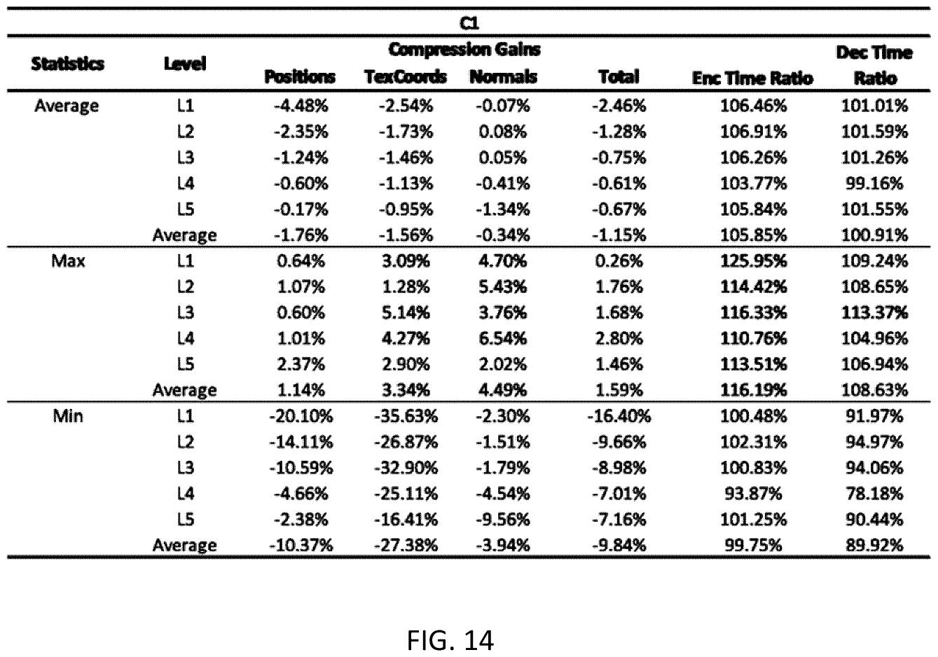

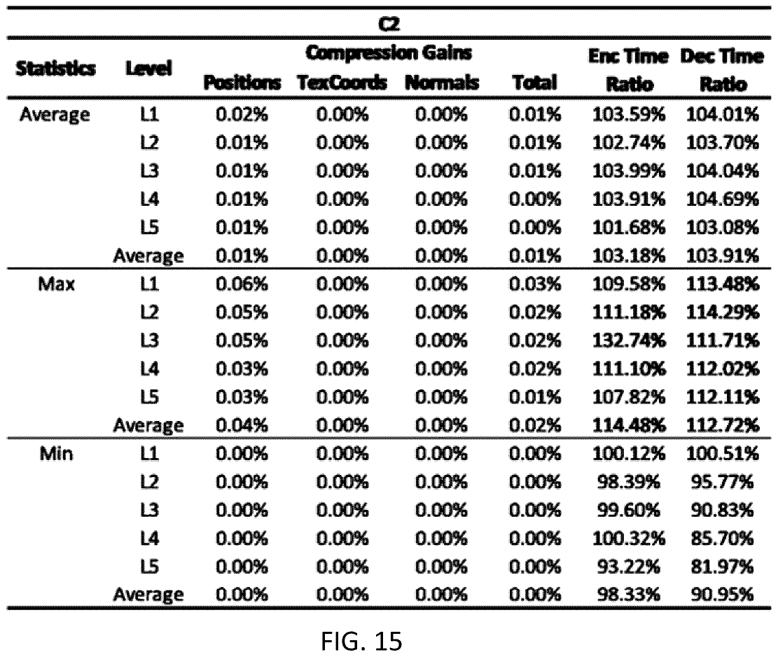

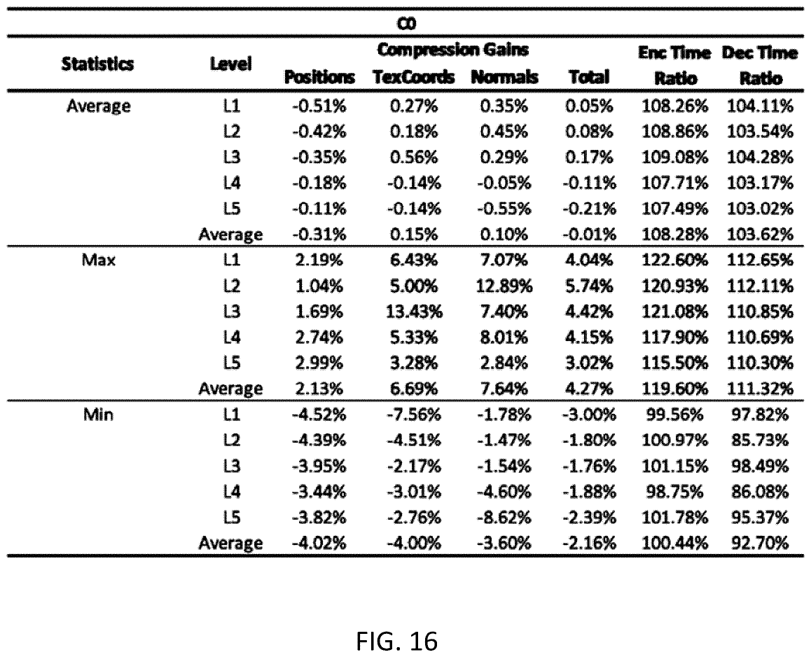

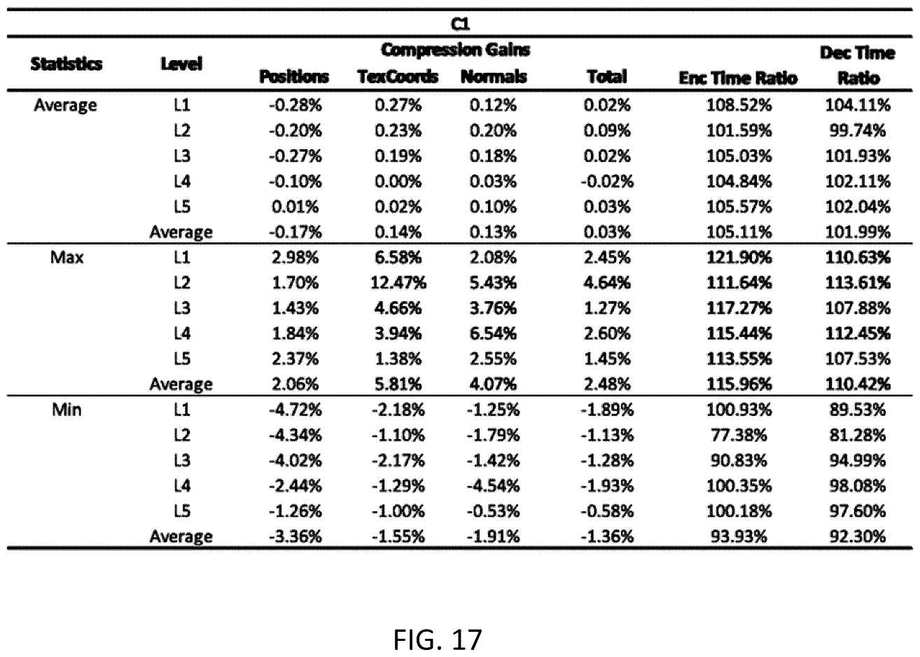

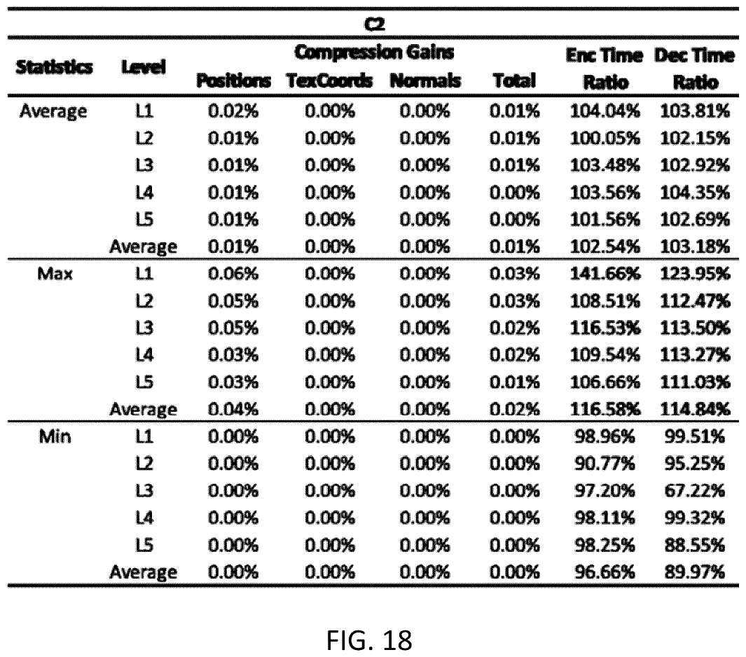

FIGS. 13-15 illustrate additional lossless results of adding a geometry slice layer (no adaptive coding mode) vs. TM 5.0a with default cfgs. FIGS. 16-18 illustrate additional lossless results of adding the geometry slice layer plus adaptive coding mode vs. TM 5.0 per-mesh cfgs.

The following figures report the released VVM polygonal mesh codec (PMC) test model v1.0, including the software changes and bug fix compared to CfP response P01, and integrated coding tools from CfP response P03. Particularly, the following figures illustrate results of integrated lossless tools from CfP response P03 and their performances.

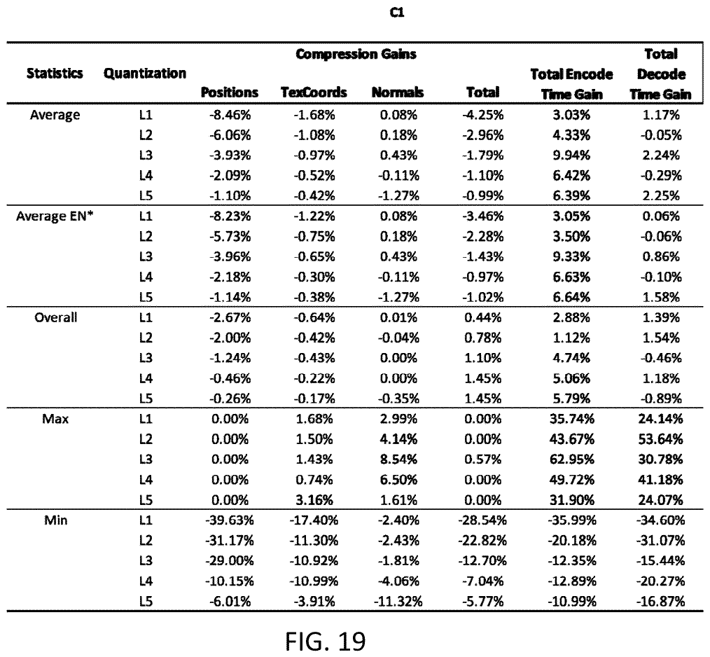

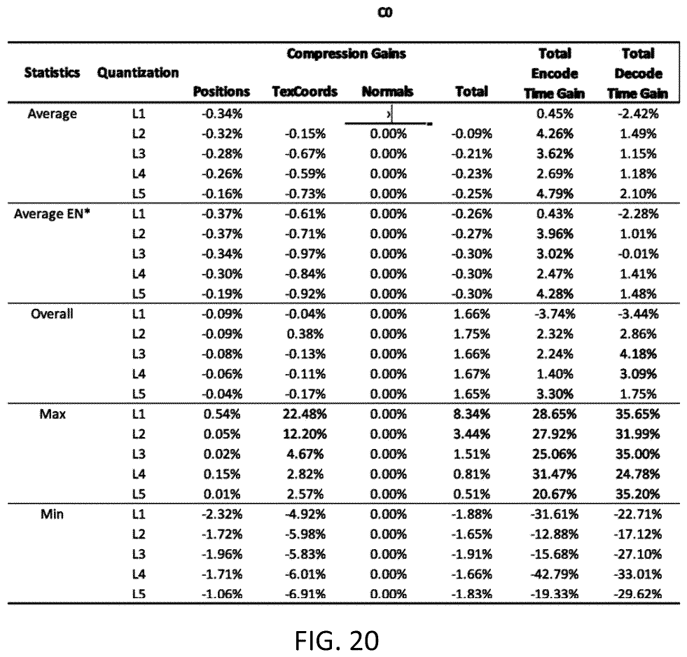

FIGS. 19 and 20 illustrate results of Dual-degree-26c6346a vs. P01T0.

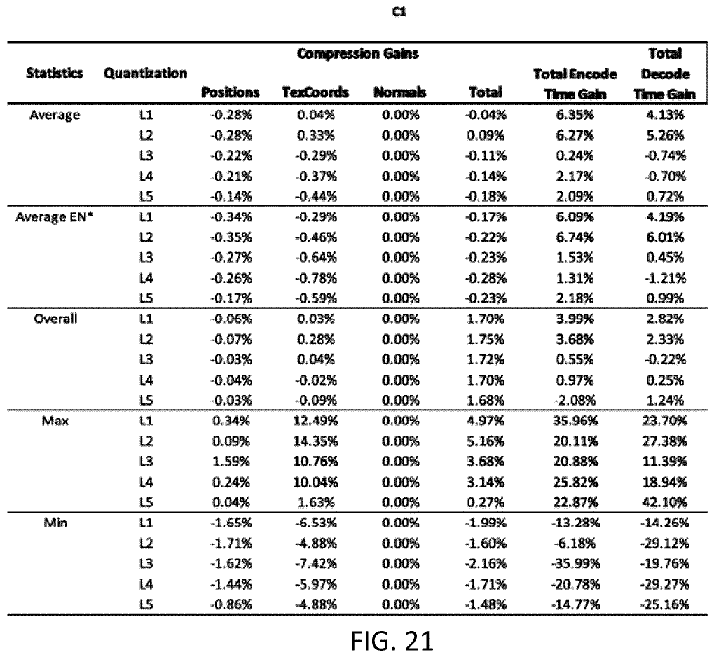

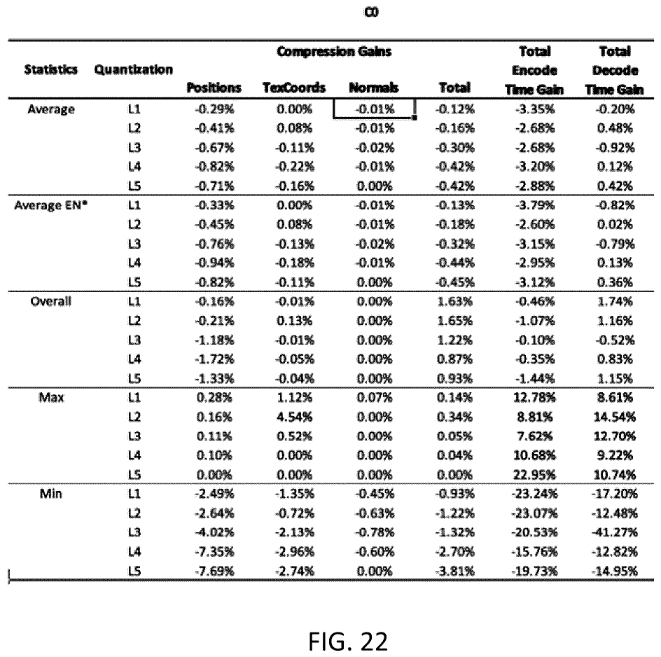

FIGS. 21 and 22 illustrate results of Parallelogram-prediction-a8fc726b vs. Dual-degree-26c6346a.

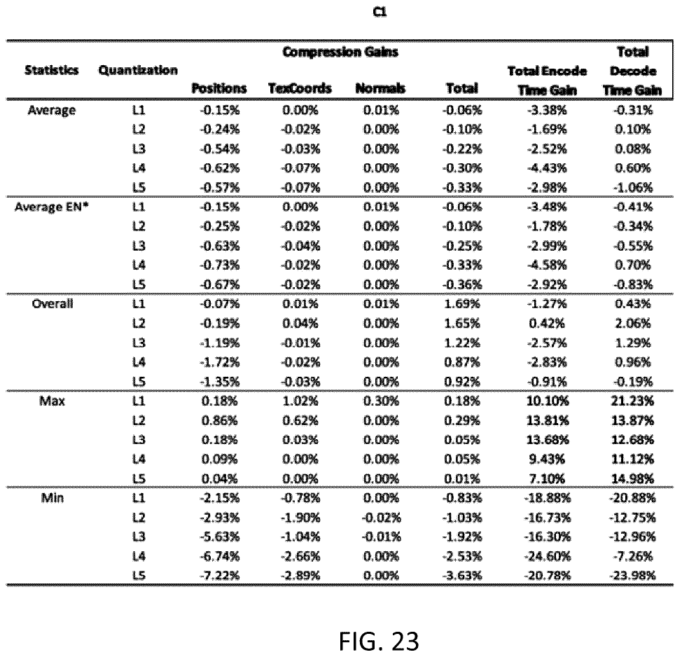

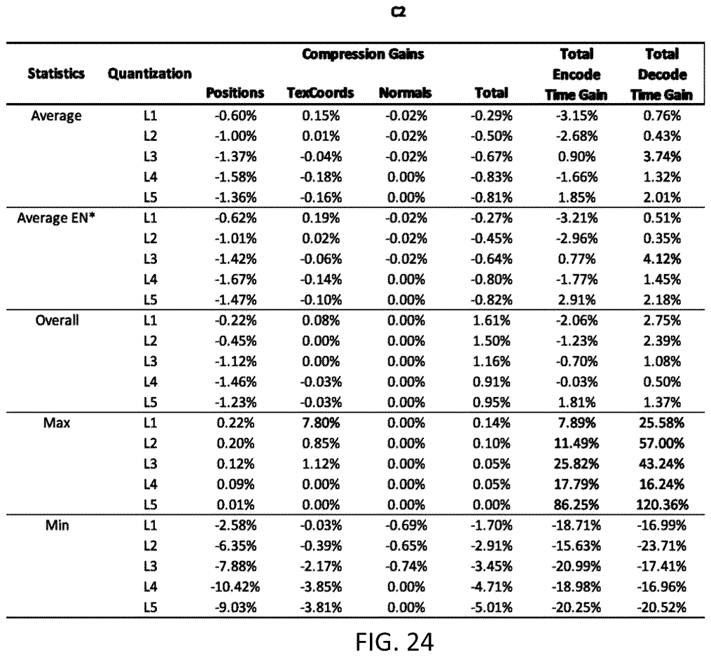

FIGS. 23 and 24 illustrate results of reflection-prediction-6f012e07 v. parallelogram-prediciton-a8fc726b.

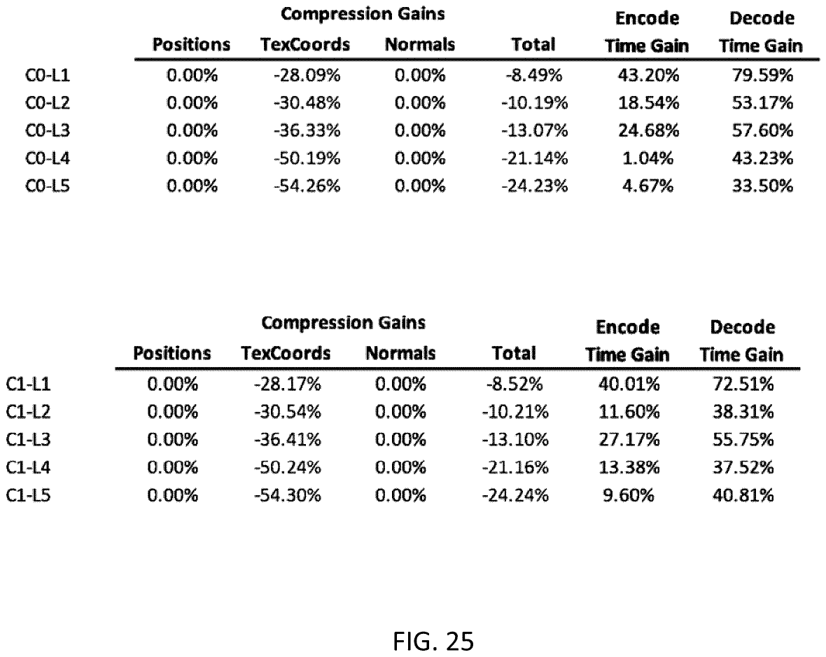

FIG. 25 illustrates results specialUV-handing-9a10dee4 vs. reflection-prediction-6f012e07.

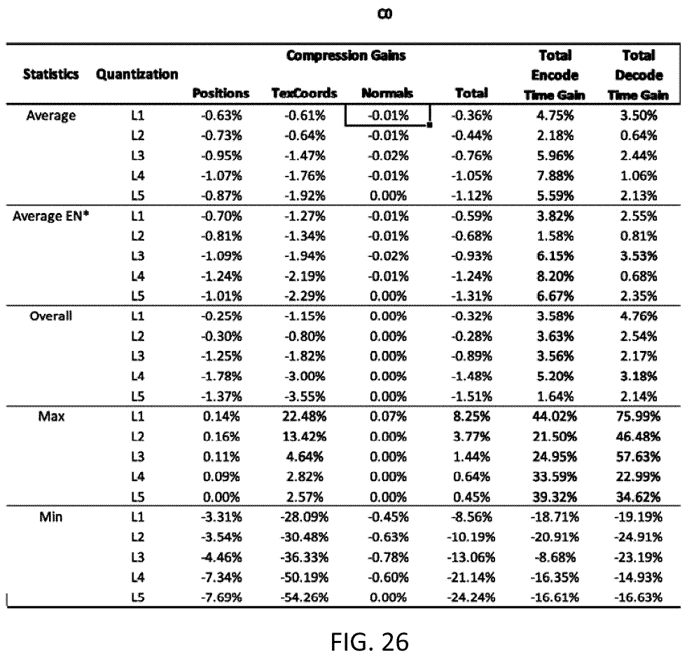

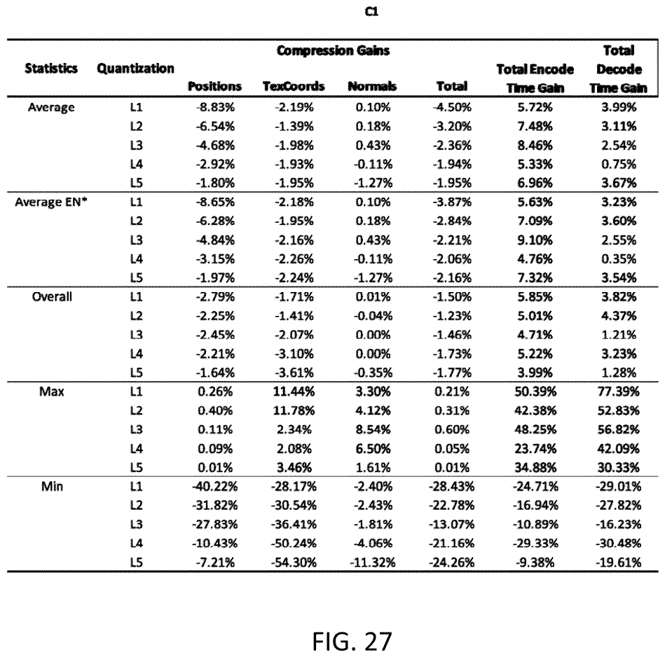

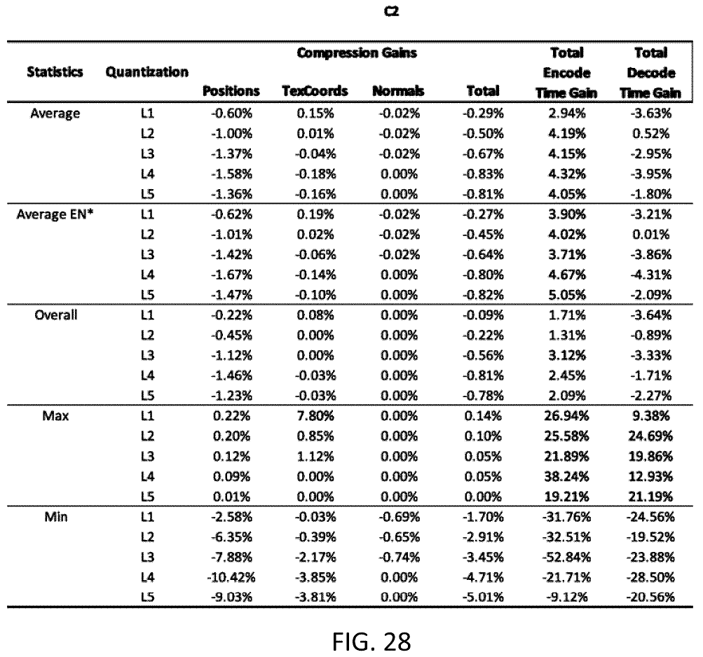

FIGS. 26-28 illustrate results of test model v1.0 vs. P01 (lossless).

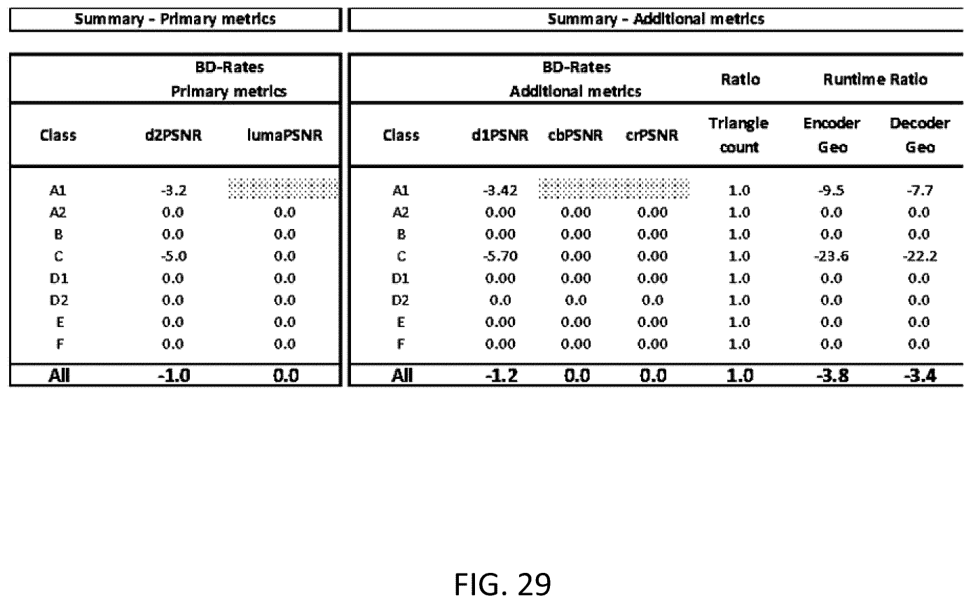

FIG. 29 illustrates an example performance of an integrated symmetric coding tool.

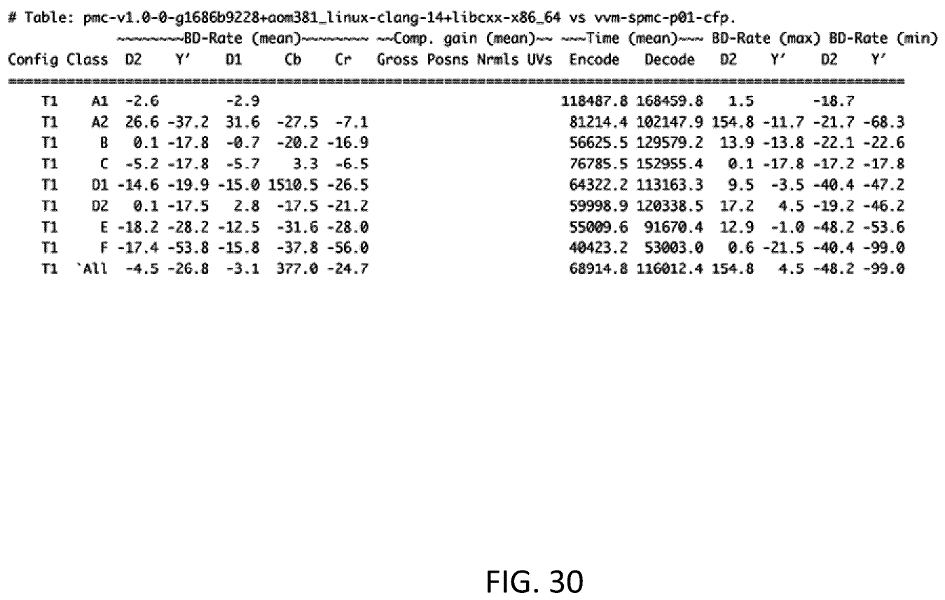

FIG. 30 illustrates an example lossy coding performance of test model 1.0 with the integrated symmetric coding tool.

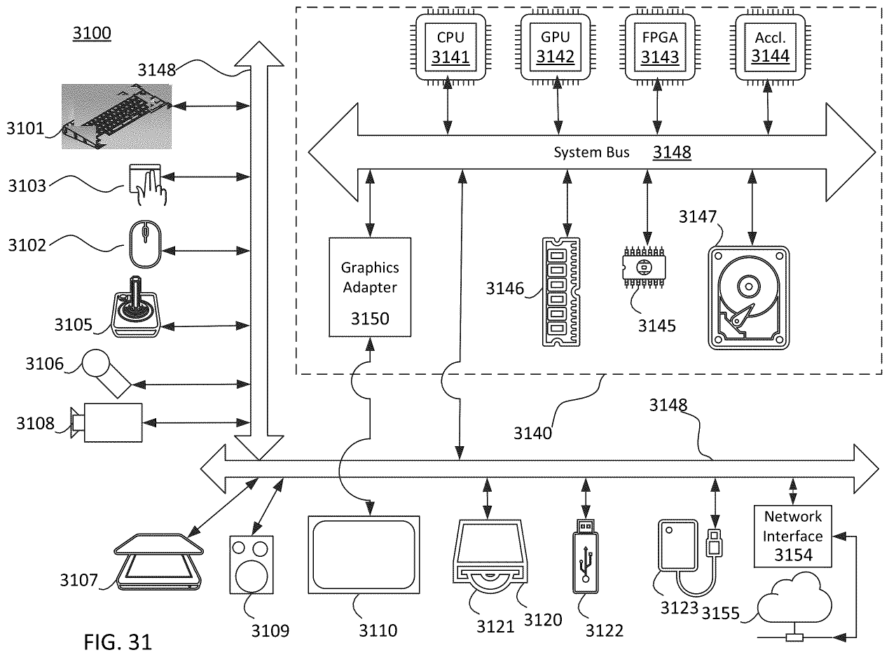

The techniques, described above, may be implemented as computer software using computer-readable instructions and physically stored in one or more computer-readable media. For example, FIG. 31 shows a computer system 3100 suitable for implementing certain embodiments of the disclosure.

The computer software may be coded using any suitable machine code or computer language, that may be subject to assembly, compilation, linking, or like mechanisms to create code including instructions that may be executed directly, or through interpretation, micro-code execution, and the like, by computer central processing units (CPUs), Graphics Processing Units (GPUs), and the like.

The instructions may be executed on various types of computers or components thereof, including, for example, personal computers, tablet computers, servers, smartphones, gaming devices, internet of things devices, and the like.

The components shown in FIG. 31 for computer system 3100 are examples and are not intended to suggest any limitation as to the scope of use or functionality of the computer software implementing embodiments of the present disclosure. Neither should the configuration of components be interpreted as having any dependency or requirement relating to any one or combination of components illustrated in the non-limiting embodiment of a computer system 3100.

Computer system 3100 may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices may also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard 3101, mouse 3102, trackpad 3103, touch screen 3110, data-glove, joystick 3105, microphone 3106, scanner 3107, camera 3108.

Computer system 3100 may also include certain human interface output devices. Such human interface output devices may be stimulating the senses of one or more human users through, for example, tactile output, sound, light, and smell/taste. Such human interface output devices may include tactile output devices (for example tactile feedback by the touch-screen 3110, data glove, or joystick 3105, but there may also be tactile feedback devices that do not serve as input devices). For example, such devices may be audio output devices (such as: speakers 3109, headphones (not depicted)), visual output devices (such as screens 3110 to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system 3100 may also include human accessible storage devices and their associated media such as optical media including CD/DVD ROM/RW 3120 with CD/DVD or the like media 3121, thumb-drive 3122, removable hard drive or solid state drive 3123, legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system 3100 may also include interface to one or more communication networks. Networks may be wireless, wireline, optical. Networks may further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses 3149 (such as, for example USB ports of the computer system 3100; others are commonly integrated into the core of the computer system 3100 by attachment to a system bus as described below (for example Ethernet interface into a PC computer system or cellular network interface into a smartphone computer system). Using any of these networks, computer system 3100 may communicate with other entities. Such communication may be uni-directional, receive only (for example, broadcast TV), uni-directional send-only (for example CANbus to certain CANbus devices), or bi-directional, for example to other computer systems using local or wide area digital networks. Such communication may include communication to a cloud computing environment 3155. Certain protocols and protocol stacks may be used on each of those networks and network interfaces as described above.

Aforementioned human interface devices, human-accessible storage devices, and network interfaces 3154 may be attached to a core 3140 of the computer system 3100.

The core 3140 may include one or more Central Processing Units (CPU) 3141, Graphics Processing Units (GPU) 3142, specialized programmable processing units in the form of Field Programmable Gate Areas (FPGA) 3143, hardware accelerators for certain tasks 3144, and so forth. These devices, along with Read-only memory (ROM) 3145, Random-access memory 3146, internal mass storage such as internal non-user accessible hard drives, SSDs, and the like 3147, may be connected through a system bus 3148. In some computer systems, the system bus 3148 may be accessible in the form of one or more physical plugs to enable extensions by additional CPUs, GPU, and the like. The peripheral devices may be attached either directly to the core's system bus 3148, or through a peripheral bus 3149. Architectures for a peripheral bus include PCI, USB, and the like. A graphics adapter 3150 may be included in the core 3140.

CPUs 3141, GPUs 3142, FPGAs 3143, and accelerators 3144 may execute certain instructions that, in combination, may make up the aforementioned computer code. That computer code may be stored in ROM 3145 or RAM 3146. Transitional data may be also be stored in RAM 3146, whereas permanent data may be stored for example, in the internal mass storage 3147. Fast storage and retrieve to any of the memory devices may be enabled through the use of cache memory, that may be closely associated with one or more CPU 3141, GPU 3142, mass storage 3147, ROM 3145, RAM 3146, and the like.

The computer readable media may have computer code thereon for performing various computer-implemented operations. The media and computer code may be those specially designed and constructed for the purposes of the present disclosure, or they may be of the kind well known and available to those having skill in the computer software arts.

As an example and not by way of limitation, the computer system having architecture 3100, and specifically the core 3140 may provide functionality as a result of processor(s) (including CPUs, GPUs, FPGA, accelerators, and the like) executing software embodied in one or more tangible, computer-readable media. Such computer-readable media may be media associated with user-accessible mass storage as introduced above, as well as certain storage of the core 3140 that are of non-transitory nature, such as core-internal mass storage 3147 or ROM 3145. The software implementing various embodiments of the present disclosure may be stored in such devices and executed by core 3140. A computer-readable medium may include one or more memory devices or chips, according to particular needs. The software may cause the core 3140 and specifically the processors therein (including CPU, GPU, FPGA, and the like) to execute particular processes or particular parts of particular processes described herein, including defining data structures stored in RAM 3146 and modifying such data structures according to the processes defined by the software. In addition or as an alternative, the computer system may provide functionality as a result of logic hardwired or otherwise embodied in a circuit (for example: accelerator 3144), which may operate in place of or together with software to execute particular processes or particular parts of particular processes described herein. Reference to software may encompass logic, and vice versa, where appropriate. Reference to a computer-readable media may encompass a circuit (such as an integrated circuit (IC)) storing software for execution, a circuit embodying logic for execution, or both, where appropriate. The present disclosure encompasses any suitable combination of hardware and software.

While this disclosure has described several non-limiting embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the embodiments listed below:
(1) A method of encoding performed by at least one processor, the method including: receiving a polygon mesh comprising a plurality of vertices defining a plurality of faces; determining, for at least a portion of the polygon mesh, a mesh face type; determining, using the mesh face type, a first parameter corresponding to a face degree mode; encoding, using the mesh face type, the first parameter corresponding to the face degree mode; and generating a bitstream comprising the polygon mesh encoded in accordance with a dual degree process, the mesh face type, and the first parameter.
(2) The method according to feature (1), in which when the mesh face type indicates that the portion of the polygon mesh comprises both triangle and quad faces, the first parameter corresponding to the face degree mode is encoded using one bit, and in which when the mesh face type indicates that the portion of the polygon mesh comprises polygon faces having more than four sides, the first parameter corresponding to the face degree mode is encoded using more than one bit.
(3) The method according to feature (1) or (2), further including: determining, using the mesh face type, a second parameter corresponding to a difference between the face degree mode and a minimum face degree and a third parameter corresponding to a difference between a maximum face degree and the face degree mode; and encoding, using the mesh face type, the second parameter and the third parameter, in which the bitstream further comprises the second parameter and the third parameter.
(4) The method according to feature (2), in which when the mesh face type indicates that the portion of the polygon mesh comprises both triangle and quad faces, the second parameter and the third parameter are encoded using one bit, and in which when the mesh face type indicates that the portion of the polygon mesh comprises polygon faces having more than four sides, the second parameter and the third parameter are encoded using more than one bit.
(5) The method according to any one of features (1)-(4), in which the mesh face type is coded using 2 bits indicating the mesh face type as one of a triangle, quadrilateral, tri-quad, and polygon.
(6) The method according to any one of features (1)-(5), in which the mesh face type is encoded using a variable number of bits.
(7) The method according to any one of features (1)-(6), in which when the portion of the mesh comprises two mesh face types, a first mesh face type is encoded using a variable number of bits and a second mesh face type is encoded using a variable number of bits.
(8) The method according to any one of features (1)-(7), further including: determining, for at least the portion of the polygon mesh, a vertex degree mode predictor using the face degree mode.
(9) The method according to feature (8), further including: determining, for at least the portion of the polygon mesh, a vertex degree mode; determining, for at least the portion of the polygon mesh, a vertex degree mode residual that is a difference between the vertex degree mode and the vertex degree mode predictor, in which the bitstream further comprises a vertex degree mode residual.
(10) The method according to feature (9), in which the vertex degree mode predictor is 6 when the face degree mode is 3, in which the vertex degree mode predictor is 4 when the face degree mode is 4, and in which the vertex degree mode predictor is 0 when the face degree mode is 0.
(11) The method according to feature 10, in which the vertex degree mode predictor is 3 when the face degree mode is not 0, 3, and 4.
(12) The method according to feature (9), in which the vertex degree mode is encoded using two bits indicating the vertex degree mode being a value that is 6, 4, 3 or 1.
(13) The method according to any one of features (1)-(12), in which the bitstream further comprises a dummy degree face mode.
(14) A method of decoding performed by at least one processor, the method includes: receiving a bitstream comprising a polygon mesh, in accordance with a dual degree process, a mesh face type for at least a portion of the polygon mesh, and a first parameter corresponding to the face degree mode for at least a portion of the mesh; and decoding, using the mesh face type, the face degree mode; decoding the portion of the polygon mesh using the mesh face type and the face degree mode.
(15) The method according to feature (14), in which when the mesh face type indicates that the portion of the polygon mesh comprises both triangle and quad faces, the first parameter corresponding to the face degree mode is encoded using one bit, and in which when the mesh face type indicates that the portion of the polygon mesh comprises polygon faces having more than four sides, the first parameter corresponding to the face degree mode is encoded using more than one bit.
(16) The method according to feature (14), in which the bitstream further comprises a second parameter corresponding to a difference between the face degree mode and a minimum face degree and a third parameter corresponding to a difference between a maximum face degree and the face degree mode.
(17) The method according to feature (16), in which when the mesh face type indicates that the portion of the polygon mesh comprises both triangle and quad faces, the second parameter and the third parameter are encoded using one bit, and in which when the mesh face type indicates that the portion of the polygon mesh comprises polygon faces having more than four sides, the second parameter and the third parameter are encoded using more than one bit.
(18) The method according to any one of features (14)-(17), in which the mesh face type is coded using 2 bits indicating the mesh face type as one of a triangle, quadrilateral, tri-quad, and polygon.
(19) The method according to any one of features (14)-(18), in which the mesh face type is encoded using a variable number of bits.
(20) A method of encoding a polygon mesh includes: generating a bitstream comprising the polygon mesh that comprises a plurality of vertices defining a plurality of faces, in which for at least a portion of the polygon mesh, a mesh face type is determined, in which using the mesh face type, a first parameter corresponding to a face degree mode is determined; in which using the mesh face type, the first parameter corresponding to the face degree mode is encoded, and in which a bitstream comprising the polygon mesh encoded in accordance with a dual degree process, the mesh face type, and the face degree mode is generated; and transmitting the generated bitstream.

What is claimed is:

1. A method of encoding performed by at least one processor, the method comprising:
receiving a polygon mesh comprising a plurality of vertices defining a plurality of faces;
determining, for at least a portion of the polygon mesh, a mesh face type;
determining, using the mesh face type, a first parameter corresponding to a face degree mode;
encoding, using the mesh face type, the first parameter corresponding to the face degree mode; and
generating a bitstream comprising the polygon mesh encoded in accordance with a dual degree process, the mesh face type, and the first parameter.

2. The method according to claim 1, wherein when the mesh face type indicates that the portion of the polygon mesh comprises both triangle and quad faces, the first parameter corresponding to the face degree mode is encoded using one bit, and
wherein when the mesh face type indicates that the portion of the polygon mesh comprises polygon faces having more than four sides, the first parameter corresponding to the face degree mode is encoded using more than one bit.

3. The method according to claim 1, further comprising:
determining, using the mesh face type, a second parameter corresponding to a difference between the face degree mode and a minimum face degree and a third parameter corresponding to a difference between a maximum face degree and the face degree mode; and
encoding, using the mesh face type, the second parameter and the third parameter,
wherein the bitstream further comprises the second parameter and the third parameter.

4. The method according to claim 2, wherein when the mesh face type indicates that the portion of the polygon mesh comprises both triangle and quad faces, the second parameter and the third parameter are encoded using one bit, and
wherein when the mesh face type indicates that the portion of the polygon mesh comprises polygon faces having more than four sides, the second parameter and the third parameter are encoded using more than one bit.

5. The method according to claim 1, wherein the mesh face type is coded using 2 bits indicating the mesh face type as one of a triangle, quadrilateral, tri-quad, and polygon.

6. The method according to claim 1, wherein the mesh face type is encoded using a variable number of bits.

7. The method according to claim 1, wherein when the portion of the mesh comprises two mesh face types, a first mesh face type is encoded using a variable number of bits and a second mesh face type is encoded using a variable number of bits.

8. The method according to claim 1, further comprising:
determining, for at least the portion of the polygon mesh, a vertex degree mode predictor using the face degree mode.

9. The method according to claim 8, further comprising:
determining, for at least the portion of the polygon mesh, a vertex degree mode;
determining, for at least the portion of the polygon mesh, a vertex degree mode residual that is a difference between the vertex degree mode and the vertex degree mode predictor,
wherein the bitstream further comprises a vertex degree mode residual.

10. The method according to claim 9, wherein the vertex degree mode predictor is 6 when the face degree mode is 3, wherein the vertex degree mode predictor is 4 when the face degree mode is 4, and wherein the vertex degree mode predictor is 0 when the face degree mode is 0.

11. The method according to claim 10, wherein the vertex degree mode predictor is 3 when the face degree mode is not 0, 3, and 4.

12. The method according to claim 9, wherein the vertex degree mode is encoded using two bits indicating the vertex degree mode being a value that is 6, 4, 3 or 1.

13. The method according to claim 1, wherein the bitstream further comprises a dummy degree face mode.

14. A method of decoding performed by at least one processor, the method comprises:
receiving a bitstream comprising a polygon mesh, in accordance with a dual degree process, a mesh face type for at least a portion of the polygon mesh, and a first parameter corresponding to the face degree mode for at least a portion of the mesh; and
decoding, using the mesh face type, the face degree mode;
decoding the portion of the polygon mesh using the mesh face type and the face degree mode.

15. The method according to claim 14, wherein when the mesh face type indicates that the portion of the polygon mesh comprises both triangle and quad faces, the first parameter corresponding to the face degree mode is encoded using one bit, and
wherein when the mesh face type indicates that the portion of the polygon mesh comprises polygon faces having more than four sides, the first parameter corresponding to the face degree mode is encoded using more than one bit.

16. The method according to claim 14, wherein the bitstream further comprises a second parameter corresponding to a difference between the face degree mode and a minimum face degree and a third parameter corresponding to a difference between a maximum face degree and the face degree mode.

17. The method according to claim 16, wherein when the mesh face type indicates that the portion of the polygon mesh comprises both triangle and quad faces, the second parameter and the third parameter are encoded using one bit, and
wherein when the mesh face type indicates that the portion of the polygon mesh comprises polygon faces having more than four sides, the second parameter and the third parameter are encoded using more than one bit.

18. The method according to claim 14, wherein the mesh face type is coded using 2 bits indicating the mesh face type as one of a triangle, quadrilateral, tri-quad, and polygon.

19. The method according to claim 14, wherein the mesh face type is encoded using a variable number of bits.

20. A method of encoding a polygon mesh, the method comprising:
generating a bitstream comprising the polygon mesh that comprises a plurality of vertices defining a plurality of faces,
wherein for at least a portion of the polygon mesh, a mesh face type is determined,
wherein using the mesh face type, a first parameter corresponding to a face degree mode is determined;
wherein using the mesh face type, the first parameter corresponding to the face degree mode is encoded, and
wherein the bitstream comprises the polygon mesh encoded in accordance with a dual degree process, the mesh face type, and the face degree mode is generated; and
transmitting the generated bitstream.
